(19) United States
(12) Patent Application Publication
(10) Pub. No.: US 2024/0181408 A1
(43) Pub. Date: Jun. 6, 2024

(54) MAGNETIC DRIVE EXTENSION FOR USE WITH VIRUS INACTIVATION SKID

(71) Applicant: AMGEN INC., Thousand Oaks, CA (US)

(72) Inventor: Bret Wylie, Thousand Oaks, CA (US)

(21) Appl. No.: 18/285,159

(22) PCT Filed: Apr. 14, 2022
(86) PCT No.: PCT/US22/24816

§ 371 Date: Sep. 29, 2023

Related U.S. Application Data
(60) Provisional application No. 63/177,607, filed on Apr. 21, 2021.

(51) Int. Cl. B01F 33/45; B01F 35/32; H01F 7/08

(52) U.S. Cl. CPC B01F 33/45; B01F 35/32005; B01F 35/3213; H01F 7/081

(57) ABSTRACT

A magnetic drive extension may be adapted to be positioned between a magnetic drive that generates a rotating magnetic field and a component, such as an agitator, driven by the magnetic drive, to increase the strength of the magnetic coupling between the drive and component. For example, a mechanical magnetic drive extension may house a rotating shaft around which a rotating magnet mount is configured to rotate, with two oppositely polarized magnets attached to opposite sides of the mount, such that the rotational force causes the rotating magnet mount to rotate, which in turn generates a second rotating magnetic field that causes a second rotational magnetic force to be applied to the component. As another example, a magnetically permeable magnetic drive extension may be comprised of an insulating material in which magnetic conductor components are embedded with even spacing around the interior perimeter of the magnetically permeable magnetic drive extension.

### CROSS-REFERENCE TO RELATED APPLICATIONS

The present application claims priority to pending U.S. Provisional Application No. 63/177,607, entitled “Magnetic Drive Extension for Use With Virus Inactivation Skid”, and filed Apr. 21, 2021, the entirety of which is incorporated herein by reference.

### FIELD OF THE DISCLOSURE

The present disclosure generally relates to mixing tanks that use agitators driven by magnetic drives, and, more particularly, to a magnetic drive extension for maintaining magnetic coupling between the magnetic drive and the agitator when the distance between the two otherwise results in insufficient magnetic coupling strength.

### BACKGROUND

Magnetic force decreases with distance squared, so, generally speaking, it is preferred that the interface distance between magnet drives and driven components be kept to a minimum. In some real-world applications, however, other factors prevent close proximity between magnet drives and driven components, resulting in weak magnetic coupling strength due to the resulting gap. For example, when a magnetic drive is used to drive an agitator component in a tank of a viral inactivation skid, the tank containing the agitator component must be supported above the ground where the magnetic drive is positioned, e.g., using stilts or legs, to allow sufficient space for drainage tubing. Consequently, the distance between the magnetic drive and the driven agitator component in the tank may increase depending on how much space is required for the drainage tubing below the tank, leading to weakening magnetic coupling strength and resulting in instances of magnetic decoupling between the magnetic drive and the driven agitator component in the tank. Currently, operators must monitor tanks and manually correct such instances of magnetic decoupling between the magnetic drive and the driven agitator component in the tank when they occur, which is an inefficient use of operator time, especially as many other aspects of viral inactivation process are becoming automated.

### SUMMARY

In an embodiment, a mechanical magnetic drive extension is provided. The magnetic drive extension is adapted to be positioned in a space between: (i) a magnetic drive configured to generate a rotating magnetic field that causes a first rotational magnetic force to be applied to a component driven by the magnetic drive, and (ii) the component driven by the magnetic drive, and the magnetic drive extension has a housing that houses a rotating shaft which a rotating magnet mount is configured to rotate, wherein two oppositely polarized magnets are attached to opposite sides of the rotating magnet mount, such that the first rotational force causes the rotating magnet mount to rotate, and such that the rotation of the rotating magnet mount generates a second rotating magnetic field that causes a second rotational magnetic force to be applied to the component.

In some examples, the mechanical magnetic drive extension is cylindrical in shape. Furthermore, in some examples, the diameter of the mechanical magnetic drive extension is substantially the same as the diameter of the magnetic drive. Moreover, in some examples, the magnetic drive extension is cylindrically oriented such that a first circular face of the magnetic drive extension faces the magnetic drive and a second circular face of the magnetic drive extension faces the component driven by the magnetic drive.

Additionally, in some examples, the component driven by the mechanical magnetic drive is an agitator. For instance, the agitator may be positioned in a mixing tank that is supported, e.g., with one or more legs, a particular distance above the magnetic drive, and the cylindrical height of the mechanical magnetic drive extension may be less than the particular distance, or substantially the same as the particular distance.

In another embodiment, a magnetically permeable magnetic drive extension is provided. The magnetically permeable magnetic drive extension is adapted to be positioned in a space between: (i) a magnetic drive configured to generate a rotating magnetic field that causes a rotational force to be applied to a component driven by the magnetic drive, and (ii) the component driven by the magnetic drive. Furthermore, the magnetically permeable magnetic drive extension is comprised of an insulating material in which one or more magnetic conductor components are embedded with even spacing around the interior perimeter of the magnetically permeable magnetic drive extension.

In some examples, the magnetically permeable magnetic drive extension is cylindrical in shape. Furthermore, in some examples, the diameter of the magnetically permeable magnetic drive extension is substantially the same as the diameter of the magnetic drive. Moreover, in some examples, the magnetically permeable magnetic drive extension is cylindrically oriented such that a first circular face of the magnetically permeable magnetic drive extension faces the magnetic drive and a second circular face of the magnetically permeable magnetic drive extension faces the component driven by the magnetic drive.

Additionally, in some examples, the component driven by the magnetically permeable magnetic drive is an agitator. For instance, the agitator may be positioned in a mixing tank that is supported, e.g., with one or more legs, a particular distance above the magnetic drive, and the cylindrical height of the magnetically permeable magnetic drive extension may be less than the particular distance, or substantially the same as the particular distance.

### BRIEF DESCRIPTION OF THE DRAWINGS

FIG. 1 illustrates an example tank containing a magnetically driven agitator and its associated drainage tubing, positioned above a magnetic drive, in accordance with some embodiments.

FIG. 2 illustrates an example tank containing a magnetically driven component, positioned above an example magnetic drive, in accordance with some embodiments.

FIG. 3 illustrates an example tank containing a magnetically driven component, positioned above an example magnetic drive, with an example magnetic drive extension positioned between the magnetic drive and the magnetically driven component, in accordance with some embodiments.

FIG. 4A illustrates a top view of an example magnetic drive extension, and FIG. 4B illustrates a side view of the example magnetic drive extension, in accordance with some embodiments.

FIG. 5A illustrates a section view of the example mechanical magnetic drive extension shown at FIG. 4B, and FIG. 5B illustrates a section view of the example mechanical magnetic drive extension show at FIG. 5A, in accordance with some embodiments.

FIG. 6A illustrates a top view of an example magnetically permeable magnetic drive extension, and FIG. 6B illustrates a section view of the example magnetically permeable magnetic drive extension shown at FIG. 6A, in accordance with some embodiments.

### DETAILED DESCRIPTION

The magnetic drive extension provided herein improves the coupling of magnetic drives to driven components, where distance between the two otherwise results in insufficient magnetic coupling strength. When drives cannot be placed directly against driven components, placing the magnetic drive extension provided herein in the gap between drives and driven components increases the strength of the magnetic coupling, and therefore improves reliability and/or performance. Generally speaking, placing the magnetic drive extension provided herein in the gap transfers axial force and/or magnetic field from drive to component more efficiently, effectively reducing the gap and improving performance. Specifically, the magnetic drive extension, either via magnetic permeable material such as ferrous metal, or mechanically through the use of additional magnets, transfers the rotational force from the magnetic drive to the intended driven component. These concepts can be applied with wide range of simple or complex forms, to achieve the principal function of enabling magnetic drives to reliably drive components at distances which would otherwise be problematic, and decrease the need for operator intervention to correct instances of magnetic decoupling.

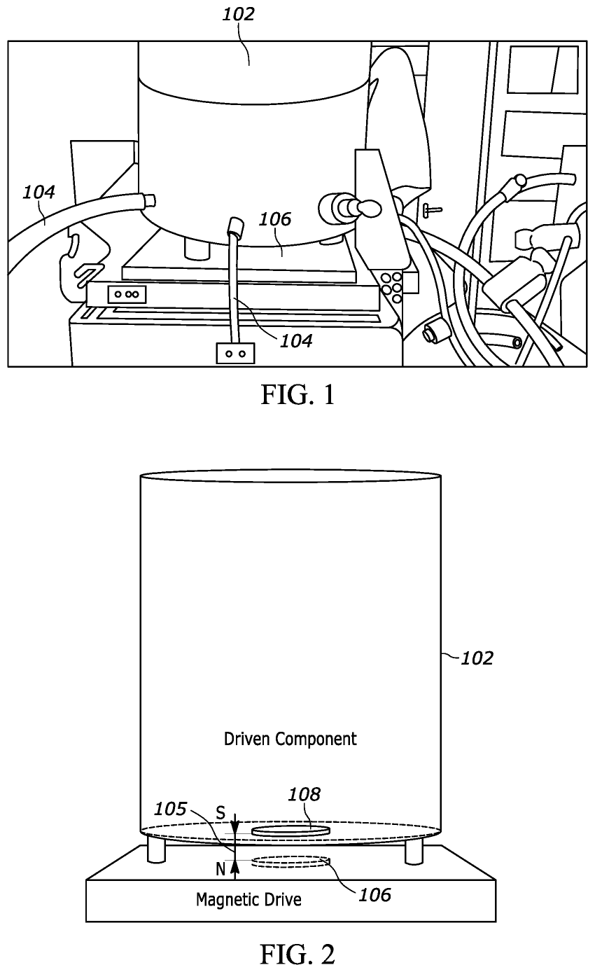

FIG. 1 illustrates an example tank 102 containing a magnetically driven agitator and its associated drainage tubing 104, positioned above a magnetic drive 106, in accordance with some embodiments. For example, the magnetic drive 106 may be used to drive an agitator component in a tank 102 of a viral inactivation skid. When regular drainage via drainage tubing 104 is required, the tank 102 must be supported above the ground (or another base) where the magnetic drive 106 is positioned so there is room for the drainage tubing 104 below the tank 102.

FIG. 2 illustrates another view of an example tank 102 containing a magnetically driven component 108 (e.g., such as an agitator), positioned above an example magnetic drive 106, in accordance with some embodiments. Generally speaking, the magnetic drive 106 and the magnetically driven component 108 both include magnets that are magnetically coupled to one another. As the magnets of the magnetic drive 106 are mechanically rotated (e.g., using a motor), the magnetic force between the magnetic drive 106 and the magnetically driven component 108 cause the magnets of the mechanically driven component 108 to rotate as well. However, as the distance 105 between the driven component 108 and the magnetic drive 106 that drives the driven component 108 increases (e.g., to make room for drainage tubing 104 below the tank 102 as discussed above with respect to FIG. 1), the strength of the magnetic coupling between the magnetically driven component 108 and the magnetic drive 106 decreases, which may lead to instances of magnetic decoupling between the magnetically driven component 108 and the magnetic drive 106.

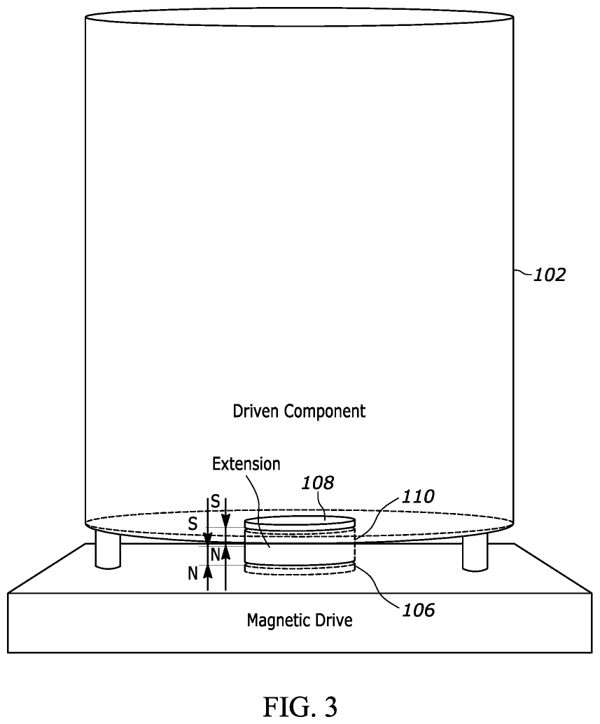

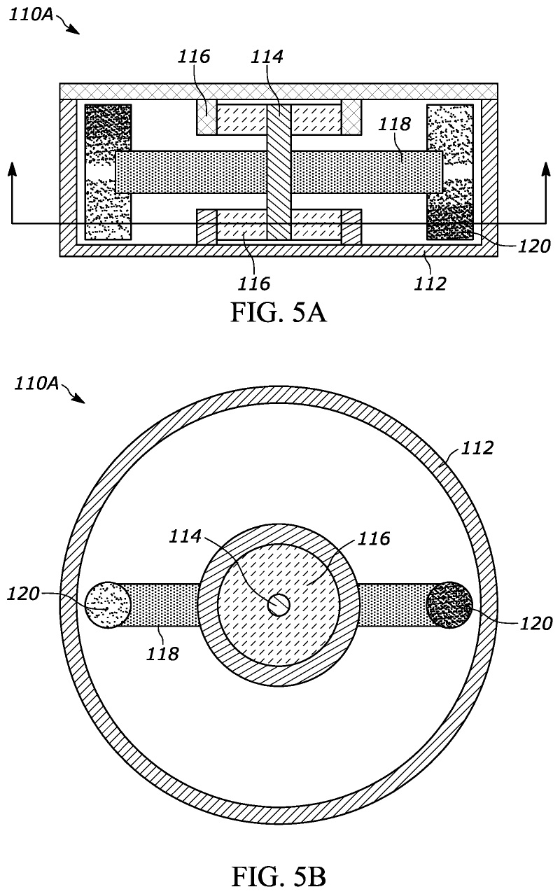

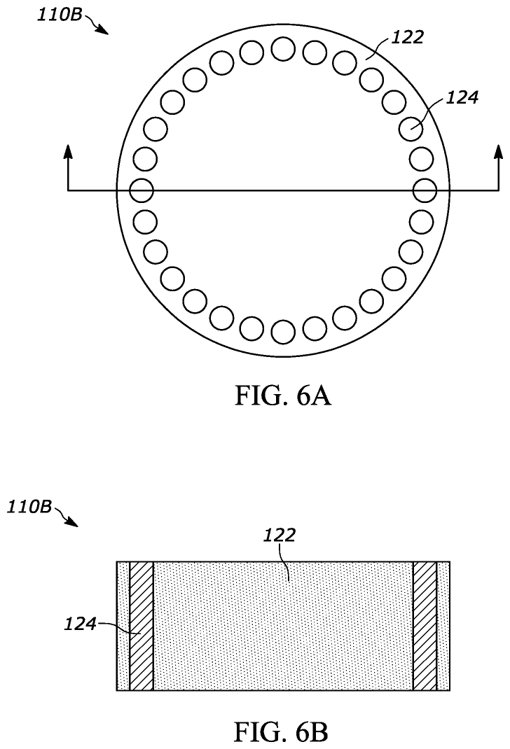

As discussed above, the present disclosure provides a magnetic drive extension 110 that improves the magnetic decoupling between the magnetically driven component 108 and the magnetic drive 106, e.g., where distance between the two otherwise results in insufficient magnetic coupling strength. FIG. 3 illustrates an example tank 102 containing a magnetically driven component 108, positioned above an example magnetic drive 106, with an example magnetic drive extension 110 positioned between the magnetic drive 106 and the magnetically driven component 108, in accordance with some embodiments. Generally speaking, positioning the magnetic drive extension 110 between the magnetic drive 106 and the magnetically driven component 108 transfers axial force and/or magnetic field from the magnetic drive 106 to the magnetically driven component 108 more efficiently, effectively bridging the gap between the magnetic drive 106 and the magnetically driven component 108 and improving the magnetic coupling between the two. Specifically, the magnetic drive extension 110 may be implemented either mechanically through the use of additional magnets (e.g., via a mechanical magnetic drive extension 110A as shown and discussed with respect to FIGS. 5A and 5B), or via magnetic permeable material such as ferrous metal (e.g., via a magnetically permeable magnetic drive extension 110B as shown and discussed with respect to FIGS. 6A and 6B), in order to transfer the rotational force from the magnetic drive 106 to the magnetically driven component 108.

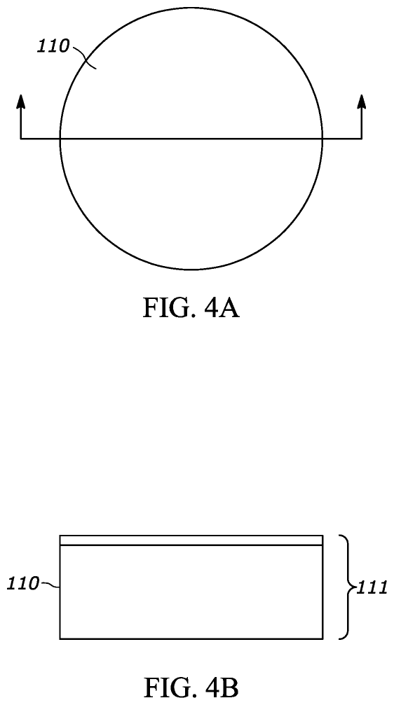

FIG. 4A illustrates a top view of an example magnetic drive extension 110, and FIG. 4B illustrates a side view of the example magnetic drive extension 110, in accordance with some embodiments. Generally speaking, the magnetic drive extension 110 may be cylindrical in shape, with a height 111 less than or equal to the distance 105 between the magnetic drive 106 and the magnetically driven component 108, or less than or equal to the distance between the magnetic drive 106 and the bottom of a tank 102 (or other container) in which the magnetically driven component 108 is positioned. When the magnetic drive extension 110 is positioned between the driven component 108 and the magnetic drive 106, one of the circular faces of the magnetic drive extension 110 may be oriented to face toward the magnetically driven component 108 while the other circular face of the magnetic drive extension 110 is oriented to face toward the magnetic drive 106.

FIG. 5A illustrates a section view of an example mechanical magnetic drive extension 110A, i.e., a section view of the example magnetic drive extension 110 shown at FIG. 4B, and FIG. 5B illustrates a section view of the example mechanical magnetic drive extension 110A shown at FIG. 5A, in accordance with some embodiments. The mechanical magnetic drive extension 110A may include a housing 112 that houses a rotating shaft 114 around which a rotating magnet mount 118 is configured to rotate, and one or more bearings 116 for the rotating magnet mount 118. Two oppositely polarized magnets 120 may be attached to opposite sides of the rotating magnet mount 118. Generally speaking, the magnets of the magnetic drive 106 may magnetically couple to the magnets 120 of the mechanical magnetic drive extension 110A, and when the magnets of the magnetic drive 106 are mechanically rotated (e.g., using a motor), the rotation of the magnets of the magnetic drive 106 causes the magnets 120 of the mechanical magnetic drive extension 110A to rotate via the rotating magnet mount 118. The magnets 120 of the mechanical magnetic drive extension 110A may further be magnetically coupled to the magnets of the magnetically driven component 108, and the rotation of the magnets 120 via the rotating magnet mount 118 may in turn cause the magnets of the magnetically driven component 108 to rotate, i.e., magnetically driving the agitator or other magnetically driven component 108 in the tank 102 or other container at a closer range than the magnetic drive 106.

FIG. 6A illustrates a top view of an example magnetically permeable magnetic drive extension 110B, and FIG. 6B illustrates a section view of the example magnetically permeable magnetic drive extension 110B shown at FIG. 6A, in accordance with some embodiments. The magnetically permeable magnetic drive extension 110B may be made of a solid insulating material 122, with one or more magnetic conductor components 124 (e.g., made of ferrous metal) embedded within the magnetically insulating material 122. Generally speaking, as shown at FIG. 6A the one or more magnetic conductor components 124 may be evenly spaced around the interior perimeter or circumference of the magnetically permeable magnetic drive extension 110B. The magnetic conductor components 124 of the magnetically permeable magnetic drive extension 110B may be aligned with the rotation path of the magnets of the magnetic drive 106. When the magnetic drive 106 is mechanically rotated (e.g., using a motor), the rotation of the magnets of the magnetic drive 106 generates a rotational magnetic field, and the one or more magnetic conductor components 124 extend the reach of the rotational magnetic field from the magnetic drive 106 to the magnetically driven component 108.

The magnetic drive extension 110, 110A, 110B provided herein can be applied with wide range of simple or complex forms, to achieve the principal function of enabling magnetic drives to reliably drive components at distances which would otherwise be problematic, and decrease the need for operator intervention to correct instances of magnetic decoupling.

The patent claims at the end of this patent application are not intended to be construed under 35 U.S.C. § 112(f) unless traditional means-plus-function language is expressly recited, such as “means for” or “step for” language being explicitly recited in the claim(s).

1. A mechanical magnetic drive extension adapted to be positioned in a space between: (i) a magnetic drive configured to generate a rotating magnetic field that causes a first rotational magnetic force to be applied to a component driven by the magnetic drive, and (ii) the component driven by the magnetic drive; the mechanical magnetic drive extension having a housing that houses a rotating shaft around which a rotating magnet mount is configured to rotate, wherein two oppositely polarized magnets are attached to opposite sides of the rotating magnet mount, such that the first rotational force causes the rotating magnet mount to rotate, and such that the rotation of the rotating magnet mount generates a second rotating magnetic field that causes a second rotational magnetic force to be applied to the component.

2. The mechanical magnetic drive extension of claim 1, wherein the mechanical magnetic drive extension is cylindrical in shape.

3. The mechanical magnetic drive extension of claim 2, wherein the diameter of the mechanical magnetic drive extension is substantially the same as the diameter of the magnetic drive.

4. The mechanical magnetic drive extension of claim 2, wherein the mechanical magnetic drive extension is cylindrically oriented such that a first circular face of the mechanical magnetic drive extension faces the magnetic drive and a second circular face of the mechanical magnetic drive extension faces the component driven by the magnetic drive.

5. The mechanical magnetic drive extension of claim 1, wherein the component driven by the magnetic drive is an agitator.

6. The mechanical magnetic drive extension of claim 5, wherein a cylindrical height of the mechanical magnetic drive extension is less than a distance above the magnetic drive at which a mixing tank in which the agitator is positioned is supported.

7. The mechanical magnetic drive extension of claim 5, wherein a cylindrical height of the mechanical magnetic drive extension is substantially the same as a distance above the magnetic drive at which a mixing tank in which the agitator is positioned is supported.

8. A magnetically permeable magnetic drive extension adapted to be positioned in a space between: (i) a magnetic drive configured to generate a rotating magnetic field that causes a rotational force to be applied to a component driven by the magnetic drive, and (ii) the component driven by the magnetic drive; the magnetically permeable magnetic drive extension being comprised of an insulating material in which one or more magnetic conductor components are embedded with even spacing around the interior perimeter of the magnetically permeable magnetic drive extension.

9. The magnetically permeable magnetic drive extension of claim 8, wherein the magnetically permeable magnetic drive extension is cylindrical in shape.

10. The magnetically permeable magnetic drive extension of claim 9, wherein the diameter of the magnetically permeable magnetic drive extension is substantially the same as the diameter of the magnetic drive.

11. The magnetically permeable magnetic drive extension of claim 9, wherein the magnetically permeable magnetic drive extension is cylindrically oriented such that a first circular face of the magnetically permeable magnetic drive extension faces the magnetic drive and a second circular face of the magnetically permeable magnetic drive extension faces the component driven by the magnetic drive.

12. The magnetically permeable magnetic drive extension of claim 8, wherein the component driven by the magnetic drive is an agitator.

13. The magnetically permeable magnetic drive extension of claim 12, wherein a cylindrical height of the magnetically permeable magnetic drive extension is less than a distance above the magnetic drive at which a mixing tank in which the agitator is positioned is supported.

14. The magnetically permeable magnetic drive extension of claim 12, wherein a cylindrical height of the magnetically permeable magnetic drive extension is substantially the same as a distance above the magnetic drive at which a mixing tank in which the agitator is positioned is supported.
